(19) United States
(12) Patent Application Publication
(10) Pub. No.: US 2012/0101956 A1
(43) Pub. Date: Apr. 26, 2012

(54) AUTONOMOUS VALIDATION OF RECEIVED SHIPMENTS

(75) Inventors: Bruce H. Hyre, Cary, NC (US); John W. Ross, JR., Raleigh, NC (US); John K. Senegal, Durham, NC (US); Donnie A. Smith, JR., Raleigh, NC (US)

(73) Assignee: INTERNATIONAL BUSINESS MACHINES CORPORATION, Armonk, NY (US)

(21) Appl. No.: 12/912,545

(22) Filed: Oct. 26, 2010

(51) Int. Cl. G06Q 10/00; G08B 13/14

(52) U.S. Cl. 705/330; 340/572.1; 705/28

(57) ABSTRACT

Advance shipment data associated with a shipment is received at an inventory controller device. The advance shipment data is verified. A data collection model is generated based upon the advance shipment data. The generated data collection model is stored within a memory. The shipment is autonomously validated by the inventory controller device using the generated data collection model in response to receipt of the shipment. An indication of a target storage location within a receiving facility is generated for each container of the validated shipment using a defined location topology model of the receiving facility including available storage locations.

### BACKGROUND

The present invention relates to receipt of shipments. More particularly, the present invention relates to autonomous validation of received shipments.

Receiving operations for shipments are processed by receiving dock personnel in warehouses. Received items are often stored within a warehouse upon arrival by use of a forklift or other equipment operated by the receiving dock personnel to avoid excessive physical strain on the receiving dock personnel.

### BRIEF SUMMARY

A method includes receiving, at an inventory controller device, advance shipment data associated with a shipment; verifying the advance shipment data; generating a data collection model based upon the advance shipment data; storing the generated data collection model within a memory; autonomously validating the shipment via the inventory controller device in response to receipt of the shipment using the generated data collection model; and generating an indication of a target storage location within a receiving facility for each container of the validated shipment using a defined location topology model of the receiving facility comprising available storage locations.

A system includes a memory; and a processor programmed to receive, at an inventory controller device, advance shipment data associated with a shipment; verify the advance shipment data; generate a data collection model based upon the advance shipment data; store the generated data collection model in the memory; autonomously validate the shipment in response to receipt of the shipment using the generated data collection model; and generate an indication of a target storage location within a receiving facility for each container of the validated shipment using a defined location topology model of the receiving facility comprising available storage locations.

A computer program product comprising a computer readable storage medium including computer readable program code, where the computer readable program code when executed on a computer causes the computer to receive advance shipment data associated with a shipment; verify the advance shipment data; generate a data collection model based upon the advance shipment data; store the generated data collection model within a memory; autonomously validate the shipment in response to receipt of the shipment using the generated data collection model; and generate an indication of a target storage location within a receiving facility for each container of the validated shipment using a defined location topology model of the receiving facility comprising available storage locations.

### BRIEF DESCRIPTION OF THE SEVERAL VIEWS OF THE DRAWINGS

FIG. 1 is a block diagram of an example of an implementation of a system for autonomous validation of received shipments according to an embodiment of the present subject matter;

FIG. 2 is a block diagram of an example of an implementation of an inventory controller capable of performing autonomous validation of received shipments according to an embodiment of the present subject matter;

FIG. 3 is a diagram of an example of an implementation of a receiving facility model for organization of receiving facility topology and radio frequency identification (RFID) associations according to an embodiment of the present subject matter;

FIG. 4 is a flow chart of an example of an implementation of a process for configuration of a system, such as an inventory controller, capable of providing autonomous validation of received shipments according to an embodiment of the present subject matter;

FIG. 5 is a flow chart of an example of an implementation of a process for processing advance shipment data to facilitate autonomous validation of received shipments according to an embodiment of the present subject matter;

FIG. 6 is a block diagram of an example of an implementation of a package level data model/structure stored within a memory that may be used to create package level data models/structures for orders according to an embodiment of the present subject matter;

FIG. 7 is a block diagram of an example of an implementation of a package level data model/structure stored within a memory and derived from an example pseudo listing of advance shipment data in the advance shipment notification according to an embodiment of the present subject matter;

FIG. 8A is a block diagram of a first portion of an example of an implementation of the package level data model/structure of FIG. 7 stored within a memory with a first portion of the advance shipment data within the advance shipment notification described above populated into the package level data model/structure according to an embodiment of the present subject matter;

FIG. 8B is a block diagram of a second portion of an example of an implementation of the package level data model/structure of FIG. 7 stored within a memory with a second portion of the advance shipment data within the advance shipment notification described above populated into the package level data model/structure according to an embodiment of the present subject matter;

FIG. 9 is a flow chart of an example of an implementation of a process for processing a shipment arrival using autonomous validation of received shipments according to an embodiment of the present subject matter; and

FIG. 10 is a flow chart of an example of an implementation of a process for validating a shipment arrival using the advance shipment data encoded within a stored package level data model/structure to facilitate autonomous validation of received shipments according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides autonomous validation of received shipments. Orders are entered and shipments are prepared for arrival and autonomous receipt validation in response to advance shipment data from one or more suppliers. A package level data model is created and stored based upon shipment information within the advance shipment data. A package level data model may also be called a data collection model herein. An anticipated arrival date associated with the advance shipment data is scheduled. To reduce outstanding tracking load, the package level data model is retrieved proximate to the anticipated arrival date. When the shipment arrives, received containers of the shipment associated with the package level data model are processed via radio frequency identification (RFID) as the containers move through one or more portals in a receiving facility. For purposes of the present description, a “container” may include any portion of a shipment or an entire shipment (e.g., an item package, a case, a pallet, a shipping container, etc.) that includes at least one item and that is transported and validated per a given implementation as a unit through a receiving portal at a receiving facility, such as a warehouse, an airport, a train station, or a shipping dock. The terms “container” and “pallet” may be used interchangeably herein as appropriate for a given example. Multiple package level data models and shipments may be received and processed concurrently through the one or more portals in the receiving warehouse. Discrepancies between the shipment and the package level data model (and thereby the advance shipment data) are documented and reported for receipt credit(s) or re-ordering and items received are documented as being received.

Locations within the receiving facility where received containers of the shipment (e.g., shipping containers, pallets, packages, items, etc.) are to be stored are identified to provide storage of items as appropriate for a given implementation. These locations may be represented within a location topology model that is used for processing advance shipment information and received shipments. Received item processing may be configured such that items may be stored in a lowest available height location (e.g., a lowest location on a shelf) within a receiving facility. Alternatively, associated items may be stored in proximity to one another while unrelated items may be stored to other locations. Where multiple associated containers of a shipment arrive on multiple pallets or within multiple shipping containers, storage locations may be clustered for convenient retrieval or additional processing of received items. Storage instructions based upon received items, for example each container, may be autonomously created and provided to receiving facility personnel, such as forklift drivers or dock workers, as the container enters the receiving facility on the forklift or crane. As such, efficiency of storage location and personnel processing of received shipments may be improved.

The autonomous validation of received shipments described herein may be performed in real time to allow prompt processing of received shipments. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

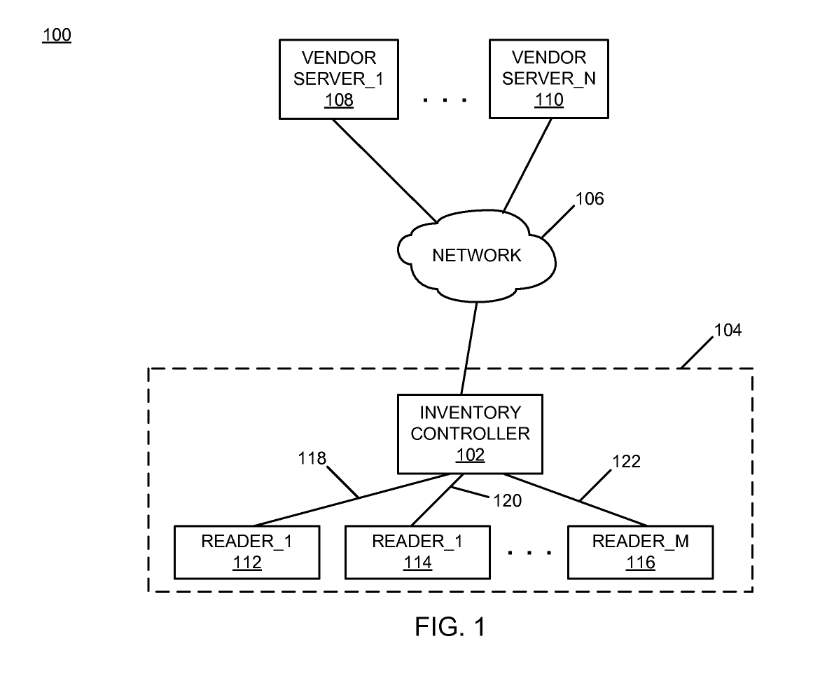

FIG. 1 is a block diagram of an example of an implementation of a system 100 for autonomous validation of received shipments. An inventory controller 102 associated with a warehouse 104 communicates via a network 106 with a vendor server_1 108 through a vendor server_N 110 to place orders for materials, products, and other items. The vendor server_1 108 through a vendor server_N 110 receive orders from the inventory controller 102 and process the orders for payment, shipment, or other processing needs as appropriate for a given implementation. The vendor server_1 108 through a vendor server_N 110 also generate, as described above and in more detail below, advance shipment data that is transmitted via the network 106 to the inventory controller 102 for processing of received shipment.

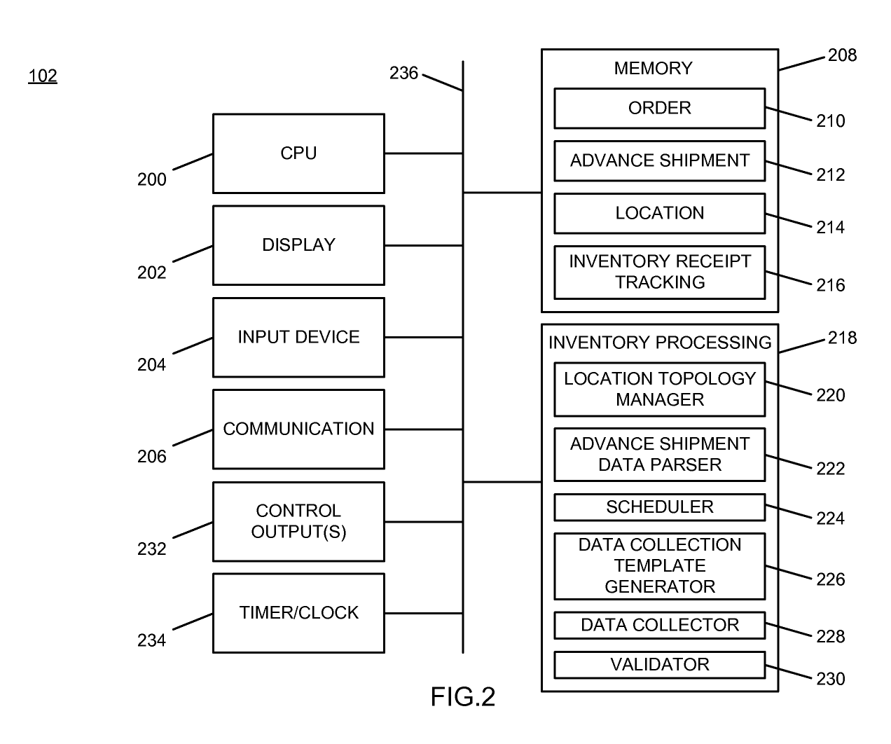

As will be described in more detail below in association with FIG. 2 through FIG. 10, the inventory controller 102 provides automated autonomous validation of received shipments. The automated autonomous validation of received shipments is based upon generation and processing of package level data models associated with shipments associated with a receiving facility, such as the warehouse 104. The automated autonomous validation of received shipments may reduce consumption of electro-mechanical energy and fuel energy of receiving facility equipment, and physical energy of receiving personnel by providing improved processing of received shipments and storage location routing and item retrieval within a receiving facility.

It should be noted that the inventory controller 102 may be a portable computing device, either by a user's ability to move the inventory controller 102 to different locations, or by the inventory controller 102's association with a portable platform, such as a forklift, warehouse personnel transportation vehicle (e.g., a golf cart), or other moving vehicle. It should also be noted that the inventory controller 102 may be any computing device capable of processing information as described above and in more detail below. For example, the inventory controller 102 may include devices such as a personal computer (e.g., desktop, laptop, etc.) or a handheld device (e.g., cellular telephone, personal digital assistant (PDA), etc.), or any other device capable of processing information as described in more detail below. The inventory controller 102 may also include an embedded device with circuitry designed specifically for inventory management and control as appropriate for a given implementation.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices.

The vendor server_1 108 through the vendor server_N 110 may include any device capable of processing orders placed by the inventory controller 102 and may be capable of providing data for consumption by a device, such as the inventory controller 102, via a network, such as the network 106. As such, the vendor server_1 108 through the vendor server_N 110 may each include a web server or other data server device as appropriate for a given implementation.

The inventory controller 102 communicates with one or more inventory receiving reader devices, depicted within the present example of FIG. 1 as reader_1 112, reader_2 114 through reader_M 116. The reader_1 112 through reader_M 116 may include radio frequency identification (RFID) devices and/or controllers for reading and processing RFID tags associated with items received at the warehouse 104. It is understood that one or more inventory receiving reader devices, such as the reader_1 112 through reader_M 116, may be associated with each portal (e.g., receiving door/doorway) associated with a receiving facility such as the warehouse 104.

The reader_1 112, reader_2 114 through reader_M 116 are shown within the present example to be interconnected with the inventory controller 102 via an interconnection 118, an interconnection 120, and an interconnection 122, respectively. This representation of interconnection is for ease of illustration purposes. It is understood that the inventory controller 102 may interconnect and communicate with the reader_1 112 through reader_M 116 via any suitable interconnection. For example, wireless communication, wired communication, networked communication, or other communication platform may be used as appropriate for a given implementation without departure from the scope of the present subject matter.

FIG. 2 is a block diagram of an example of an implementation of an inventory controller, such as the inventory controller 102, capable of performing autonomous validation of received shipments. A central processing unit (CPU) 200 provides computer instruction execution, computation, and other capabilities within the inventory controller 102. A display 202 provides visual information to a user of the inventory controller 102 and an input device 204 provides input capabilities for the user.

The display 202 may include any display device, such as a cathode ray tube (CRT), liquid crystal display (LCD), light emitting diode (LED), projection, touchscreen, or other display element or panel. The input device 204 may include a computer keyboard, a keypad, a mouse, a pen, a joystick, or any other type of input device by which the user may interact with and respond to information on the display 202.

It should be noted that the display 202 and the input device 204 may be optional components for the inventory controller 102 for certain implementations, such as an embedded implementation. For example, processing associated with making payments for received shipments, generating visual output or reports, and other functionality may be associated with the inventory controller 102, or the inventory controller 102 may be implemented as an embedded device that is ruggedized for a warehouse environment with such functionality partitioned into a different computing device (not shown) within an office portion of the warehouse 104, with the inventory controller 102 interconnected for inventory validation purposes. Accordingly, the inventory controller 102 may operate as a completely automated embedded device without user configurability or feedback. However, the inventory controller 102 may also provide user feedback and configurability via the display 202 and the input device 204, respectively, as appropriate for a given implementation.

A communication module 206 provides interconnection capabilities that allow the inventory controller 102 to communicate with other modules within the system 100, such as the vendor server_1 108 through the vendor server_N 110 and the reader_1 112 through the reader_M 116, to perform the autonomous validation of received shipments described herein. The communication module 206 may include any electrical, protocol, and protocol conversion capabilities useable to provide the interconnection capabilities. Though the communication module 206 is illustrated as a component-level module for ease of illustration and description purposes, it should be noted that the communication module 206 may include any hardware, programmed processor(s), and memory used to carry out the functions of the communication module 206 as described above and in more detail below. For example, the communication module 206 may include additional controller circuitry in the form of application specific integrated circuits (ASICs), processors, antennas, and/or discrete integrated circuits and components for performing communication and electrical control activities associated with the communication module 206. Additionally, the communication module 206 may include interrupt-level, stack-level, and application-level modules as appropriate. Furthermore, the communication module 206 may include any memory components used for storage, execution, and data processing for performing processing activities associated with the communication module 206. The communication module 206 may also form a portion of other circuitry described without departure from the scope of the present subject matter.

A memory 208 includes several storage areas for order and inventory tracking and processing. Within the present example, an order information storage area 210 stores information associated with outstanding orders that have been placed, such as via the vendor server_1 108 through the vendor server_N 110. An advance shipment information storage area 212 stores advance shipment data for anticipated shipments, scheduling information for anticipated arrival of shipments, data collection templates, and package level data models for outstanding orders. A location information storage area 214 stores warehouse location information, including available locations for storage of received items (including row, rack, shelf and other information), locations of items that have been received, information associated with preferred areas for storage of items of certain types or descriptions, and other location information as appropriate for a given implementation. An inventory receipt tracking information storage area 216 stores information associated with processing of one or more shipments while receipt is in process, such as comparison information for items processed during receipt of a shipment compared to the associated outstanding order. Other storage areas may be implemented or information for other uses may be stored in the example storage areas as appropriate for a given implementation.

It is understood that the memory 208 may include any combination of volatile and non-volatile memory suitable for the intended purpose, distributed or localized as appropriate, and may include other memory segments not illustrated within the present example for ease of illustration purposes. For example, the memory 208 may include a code storage area, an operating system storage area, a code execution area, and a data area or other areas without departure from the scope of the present subject matter.

An inventory processing module 218 is also illustrated. The inventory processing module 218 provides order processing, package level data model generation, inventory management, item receipt tracking, and other processing for the inventory controller 102, as described above and in more detail below. The inventory processing module 218 implements the autonomous validation of received shipments of the inventory controller 102.

A system for autonomous validation of received shipments, as described in more detail below, may include sensors, such as motion detectors and infrared beams, for automated control of devices. Additionally, actuators, such as light stacks and alarms, for visual or audio display of validation results, may be included. Further, devices, such as RFID readers, for capturing and transmitting RFID data from sources such as RFID tags, may be included. Processing capabilities capable of controlling these devices, sensors, and actuators, and processing RFID data may also be implemented. As such, though specific elements of the example inventory processing module 218 are described below, it is understood that other modules and different partitioning between the respective modules may be implemented as appropriate for a given implementation. Additionally, the inventory controller 102 and/or the inventory processing module 218 may be referenced herein generally to indicate reference to one or more of the respective components/elements/modules of the inventory controller 102 and/or inventory processing module 218 for ease of description purposes.

Several example modules are shown associated with the inventory processing module 218. A location topology manager module 220, an advance shipment data parser module 222, a scheduler module 224, a data collection template generator module 226, a data collector module 228, and a validator module 230, are shown within the present example.

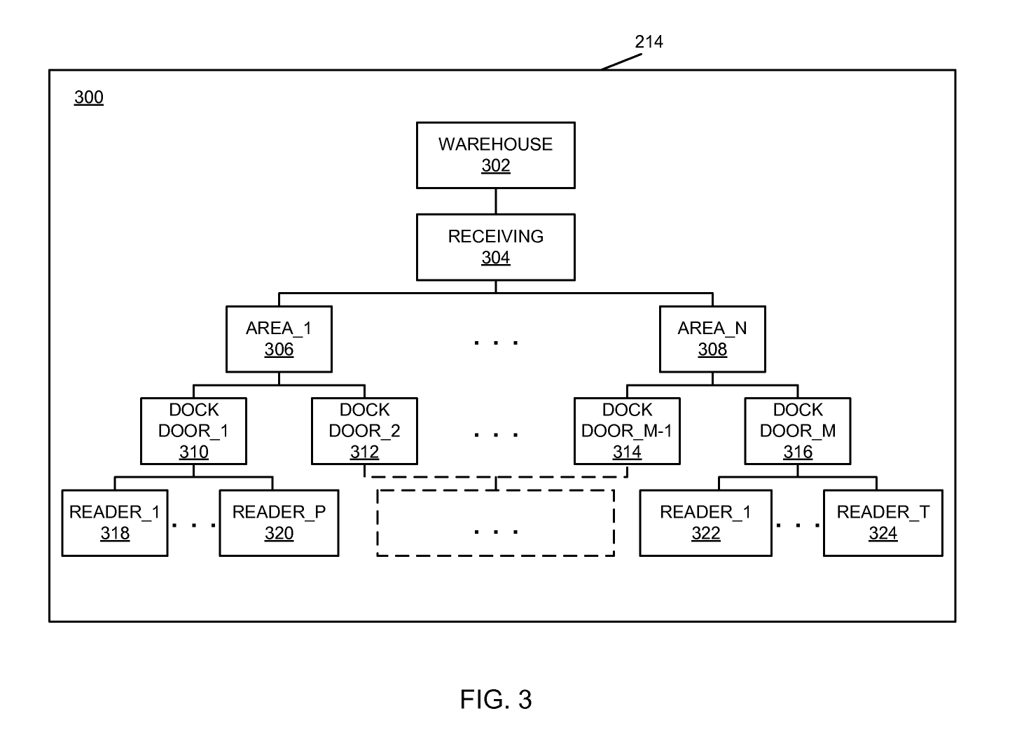

The location topology manager module 220 provides management of location information, such as the information stored within the location information storage area 214 for processing of shipments upon receipt, or post-receipt processing of items of received shipments. The location topology manager module 220 maintains a logical location hierarchy that maps relevant physical areas of a receiving site, such as the warehouse 104, to physical locations and RFID interrogators to form device associations within such a facility. For purposes of the present description, a location may be considered relevant if it can serve as a logical source of RFID data or for storage of one or more received items. Each location may be associated with zero or more RFID interrogator devices that represent the physical data sources. The location topology is transmitted to the data collector module 228 as a logical reader hierarchy so that any relevant location may be referenced within a data collection template as an RFID data source or a candidate storage location. The data collector module 228 may then make tag data from any device associated with a location within the hierarchy available for potential inclusion within a report. For purposes of illustration, FIG. 3 described in detail below depicts an example topology for a receiving facility (e.g., a warehouse) that will be used as an example throughout this description.

The advance shipment data parser module 222 processes advance shipment information, such as that stored in the advance shipment information storage area 212, to provide data source parsing technique mappings. The advance shipment data parser 222 is responsible for translating received advance shipment data for each order into a package level data model, persisting the package level structure to storage, such as within the advance shipment storage location 212, and then either immediately passing the information along to the data collection template generator module 226 or creating a task with the scheduler module 224 that will trigger an event to invoke action by the data collection template generator module 226 to generate a data collection template at a later time. Because advance shipment data may potentially arrive in many different formats, the advance shipment data parser 222 provides mapping between messages, message sources, and other translation capabilities for processing advance shipment data into a format for further processing.

The scheduler module 224 provides scheduling management, such as initial scheduling for receipt of shipments based upon advance shipment data, retrieval of package level data models for anticipated shipments, and other scheduling functions. The scheduler module 224 accepts tasks for generating data collection templates and transmitting them to the data collector module 228 at an appropriate time. The scheduler module 224 may implement data padding rules that provide flexibility for expected arrival dates for shipments. Because shipment arrival dates are estimates, it may be desirable to have the ability to configure a value by which the arrival date will be padded. This padding may ameliorate the possibility of a shipment arriving either prior to or after the anticipated arrival data. The padding value may be based on, for example, the particular supplier or type of shipment and may be further based upon known historical deviations (e.g., this supplier is always early or late by a statistical deviation from scheduled arrival dates, etc.).

The data collection template generator module 226 generates templates specifying how data is to be collected, processed, and reported based upon a package level data model or structure and a configured template generation strategy. The data collection template generator module 226 transmits these templates to the data collector module 228. The data collection template generator module 226 may be configured with a strategy dictating how (and how many) templates are to be generated for a particular shipment based upon one or more configured receiving processes. The selected strategy may affect processing aspects, such as a number of templates generated and/or used for processing an order, a number of logical readers associated with a receiving facility, how varying levels of the package structure may be represented, and other processing aspects as appropriate for a given implementation. The example scenario used herein describes complete validation (i.e. pallet, case, and item tags) as containers are being offloaded and moved through each dock door portal of a receiving facility. This form of processing may be implemented, for example, using a single template per shipment (in such an implementation, the data collector module 228 may be configured to support multiple report types per template) and using nodes of a receiving facility model (See elements of FIG. 3 described below) as a logical reader name with a report per pallet scheme that includes a pallet RFID tag, the pallet's RFID case tags, and each item RFID tag within each case on each pallet.

The data collector module 228 accumulates, filters, groups, counts, and reports data according to one or more data collection templates which may be based upon a logical RFID reader topology (again, see elements of FIG. 3 described below) within a receiving facility. As such, inclusion filters for expected RFID tags associated with each node (e.g., a pallet, case, etc.) of a package level data model may be established. For purposes of the present description, an “inclusion filter” may be considered a specified set of RFID tags to be counted to the exclusion of all others. In order to recognize logical sources of RFID data (such as data described in association with FIG. 3 below), the data collector module 228 may be configured with a logical reader hierarchy based on a location topology (again as described below in association with FIG. 3). Transmission of this information may be considered the responsibility of the location topology manager module 220.

The validator module 230 receives reports from the data collector module 228 and validates data within the reports against the original shipment information (obtained as advance shipment data) using a package level structure (see FIG. 3) persisted within the data store. A configured validation threshold (e.g., 100%, 90%, etc.) determines what percentage of tags may be missing from a given report and still pass validation. A validation threshold depth determines how far down, given a starting point indicated in a given report, within the package level structure the validator module 230 should go to obtain an expected item count (e.g., a validation item count). In the example scenario described below, a starting point may be a pallet, and the validator module 230 may proceed through the case and item levels to obtain the correct expected item count. The validator module 230 may then issue an “accept” or “reject” message that may, in certain implementations, be further processed to generate a green or red light, an alarm sounding, a conveyor stopping or having its speed increased, or other output based upon the autonomous validation performed by the validator module 230.

These outputs may be generated and output via the communication module 206 to other control modules via one or more network interconnections or may be generated as a direct output control via a control output(s) module 232. The control output(s) module 232 may provide control signaling to one or more lights (e.g., green or red lights), an audible or visible alarm, a conveyor programmable logic controller (PLC) device or embedded control device or any other control function appropriate for a given implementation.

A timer/clock module 234 is illustrated and used to determine timing and date information, such as inter-arrival times of packages or pallets of items through a receiving facility dock door (e.g., an RFID portal), as described in more detail below. As such, the inventory processing module 218 may utilize information derived from the timer/clock module 234 for information processing activities, such as the autonomous validation of received shipments.

Configuration of the templates and data models described above may be set prior to system operation and may be considered to be predominately static (or dynamic as appropriate for a given implementation). When a change occurs to the physical site layout or operational procedures, modifications may be made to templates or generated data models to incorporate these changes. The respective modules may be configured to periodically evaluate RFID readers and other processing inputs to determine whether changes have occurred. Configuration inputs may be provided to the inventory controller 102 to allow autonomous recognition of changes. Many other possibilities exist for processing facility or operational procedures and all are considered within the scope of the present subject matter.

Though the inventory processing module 218 is illustrated as a component-level module for ease of illustration and description purposes, it should be noted that the inventory processing module 218 may include any hardware, programmed processor(s), and memory used to carry out the functions of this module as described above and in more detail below. For example, the inventory processing module 218 may include additional controller circuitry in the form of application specific integrated circuits (ASICs), processors, and/or discrete integrated circuits and components for performing communication and electrical control activities associated with the respective devices. Additionally, the inventory processing module 218 may include interrupt-level, stack-level, and application-level modules as appropriate. Furthermore, the inventory processing module 218 may include any memory components used for storage, execution, and data processing for performing processing activities associated with the module.

It should also be noted that the inventory processing module 218 may form a portion of other circuitry described without departure from the scope of the present subject matter. Further, the inventory processing module 218 may alternatively be implemented as an application stored within the memory 208. In such an implementation, the inventory processing module 218 may include instructions executed by the CPU 200 for performing the functionality described herein. The CPU 200 may execute these instructions to provide the processing capabilities described above and in more detail below for the inventory controller 102. The inventory processing module 218 may form a portion of an interrupt service routine (ISR), a portion of an operating system, a portion of a browser application, or a portion of a separate application without departure from the scope of the present subject matter.

The CPU 200, the display 202, the input device 204, the communication module 206, the memory 208, the inventory processing module 218, and the control output(s) module 232, and the timer/clock module 234 are interconnected via an interconnection 236. The interconnection 236 may include a system bus, a network, or any other interconnection capable of providing the respective components with suitable interconnection for the respective purpose.

While the inventory controller 102 is illustrated with and has certain components described, other modules and components may be associated with the inventory controller 102 without departure from the scope of the present subject matter. Additionally, it should be noted that, while the inventory controller 102 is described as a single device for ease of illustration purposes, the components within the inventory controller 102 may be co-located or distributed and interconnected via a network without departure from the scope of the present subject matter. For a distributed arrangement, the display 202 and the input device 204 may be located at a point of sale device, kiosk, or other location, while the CPU 200 and memory 208 may be located at a local or remote server. Many other possible arrangements for components of the inventory controller 102 are possible and all are considered within the scope of the present subject matter. Accordingly, the inventory controller 102 may take many forms and may be associated with many platforms.

FIG. 3 is a diagram of an example of an implementation of a receiving facility model 300 for organization of receiving facility topology and radio frequency identification (RFID) associations. The receiving facility model 300 is shown stored within the location information storage area 214 of the memory 208. Within FIG. 3, a warehouse 302 includes a higher-level receiving element 304. The receiving element 304 may be considered a first location within the warehouse 302 that has access to RFID data from all readers flowing into it. The examples described herein will use this location as the data source within a data collection template to provide system autonomy. Using the first location within the topology encompassing all possible RFID data sources allows the automatic generation and submittal of data collection templates to the data collector module 228. No human interaction is required.

An area_1 306 through an area_N 308 each encapsulate reader information for one or more doors (e.g., warehouse portals) through which received pallets, cases, or items may flow upon arrival. Within the present example, the area_1 306 through the area_N 308 each include two doors, dock door_1 310 and dock door_2 312, and dock door_M-1 314 and dock door_M 316, respectively. It is understood that one or more readers may be associated with each dock door through which received items are to be autonomously processed. Within the present example, the dock door_1 310 includes an RFID reader_1 318 through an RFID reader_P 320. Similarly each other of the dock door_2 312 through the dock door_M 316 has one or more RFID readers associated with it (not all shown to avoid crowding of elements within FIG. 3), concluding with the RFID reader_1 322 through the RFID reader_T 324 that are associated with the dock door_M 316. For purposes of the present description, each of the RFID reader_1 318 through the RFID reader_T 324 may be considered an RFID interrogator.

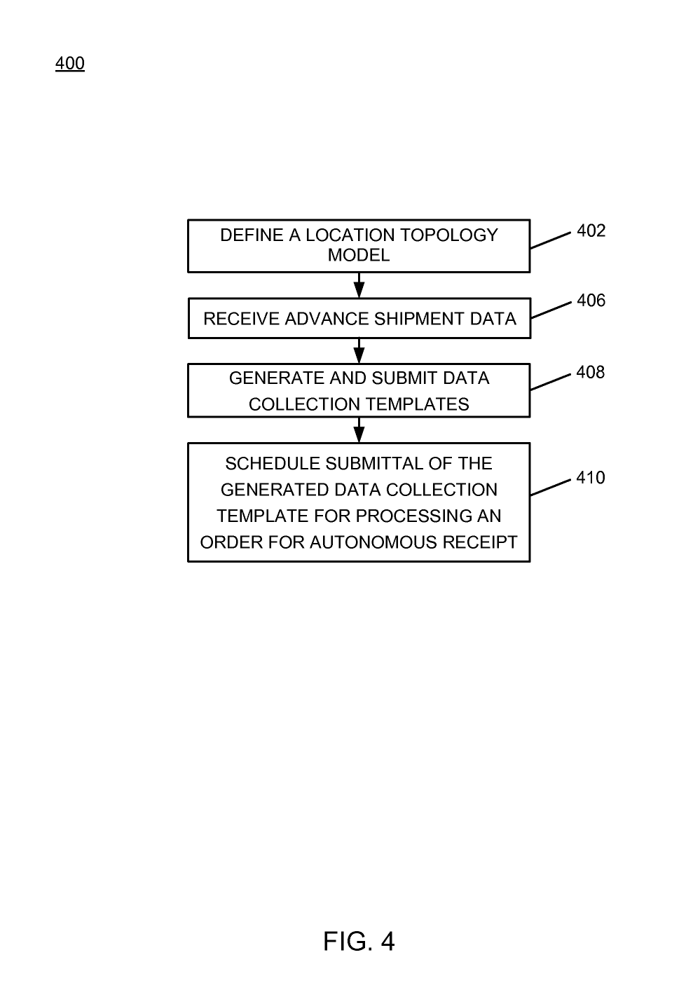

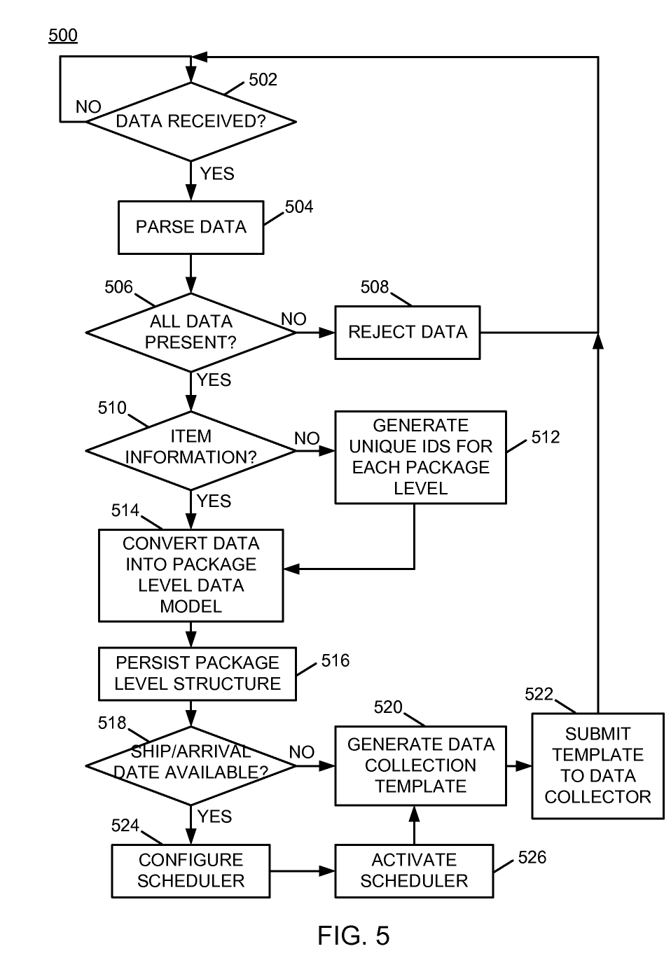

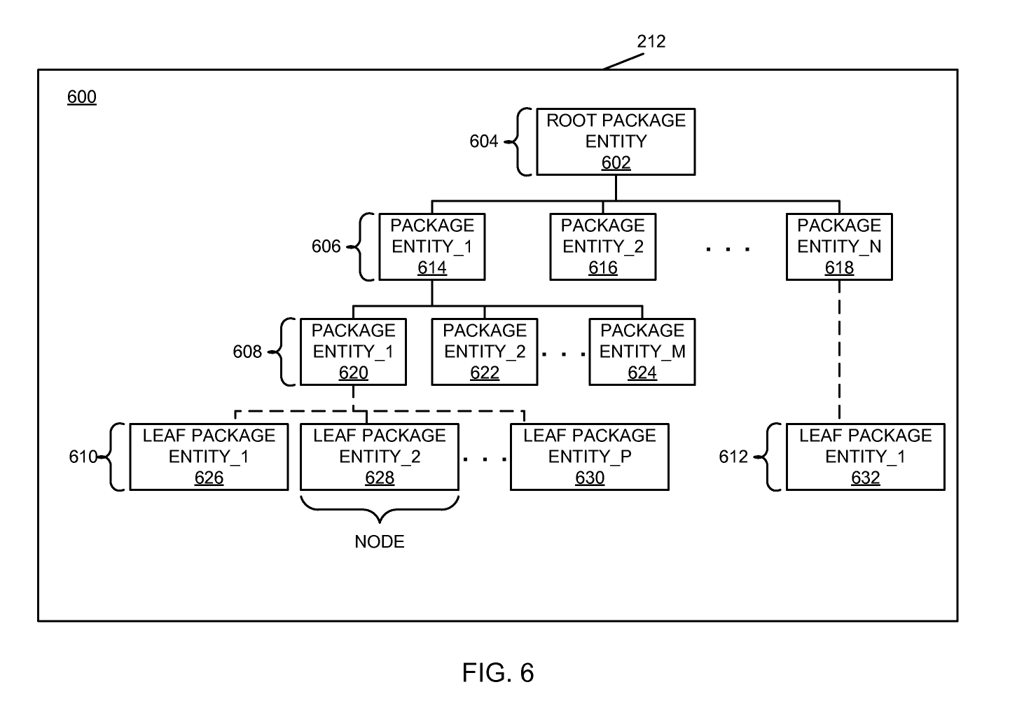

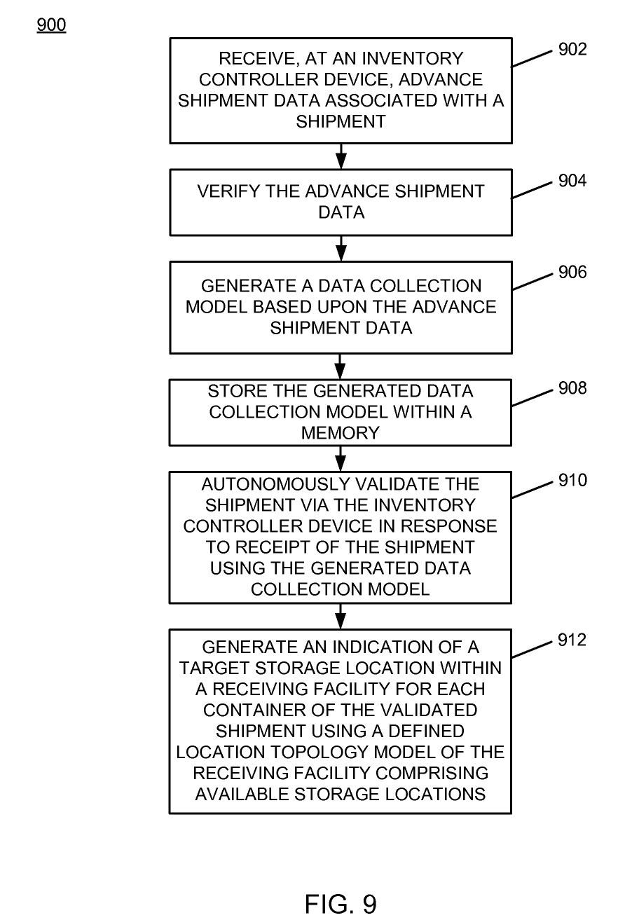

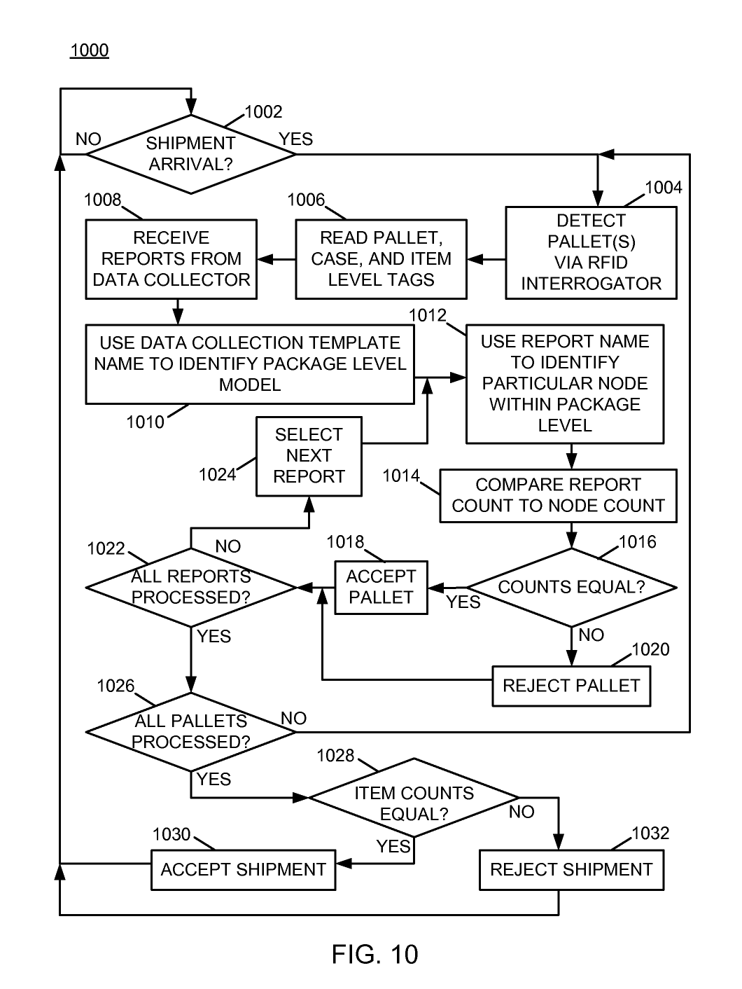

FIG. 4, FIG. 5, FIG. 9, and FIG. 10 below describe example processes that may be executed by devices, such as the inventory controller 102, to perform the autonomous validation of received shipments associated with the present subject matter. FIG. 6 through FIG. 8B below describe package level data model/structures stored within the memory 208 that may be used to create package level data models/structures for orders. Many other variations on the example processes and structures are possible and all are considered within the scope of the present subject matter. The example processes may be performed by modules, such as the inventory processing module 218 and/or executed by the CPU 200, associated with such devices. It should be noted that time out procedures and other error control procedures are not illustrated within the example processes described below for ease of illustration purposes. However, it is understood that all such procedures are considered to be within the scope of the present subject matter. Further, the processing described below may be considered to fall within three general categories of processing: system configuration, arrival of advance shipment data (and formation of data processing templates for autonomous processing of received shipments), and actual arrival and processing of shipments.

FIG. 4 is a flow chart of an example of an implementation of a process 400 for configuration of a device, such as the inventory controller 102, capable of providing autonomous validation of received shipments. A configuration interface may be provided for the inventory controller 102 via either the display 202 and the input device 204, or via a network connection from a configuration server or device (not shown). For purposes of the present example, it is assumed that configuring the device is performed using predominately static settings such that modification may be performed if the physical site layout changes or a large scale shift in business processes occurs. Such static configuration may help to facilitate autonomy of inventory processing by the inventory controller 102.

At block 402, the process 400 defines a location topology model, such as a model of the receiving facility model 300 of FIG. 3. Defining a location topology model may include defining a location topology that matches a vendor's business processes and within which each location represents a useful source of RFID data.

At block 404, the process 400 receives advance shipment data. Receiving advance shipment data may include translating the advance shipment data into a generic package level structure/model that is stored, such as in the advance shipment information storage area 212 of the memory 208. The generic package level structure/model may be used for defining data collection templates indicating how the RFID data should be processed, and for validating the received RFID data against the original shipment information.

At block 406, the process 400 generates and submits data collection templates. Generating and submitting data collection templates may be performed upon arrival of the advance shipment data so the inventory controller 102 is ready to receive the shipment at any time. Generating and submitting data collection templates further promotes autonomy of the inventory controller 102.

It should be noted that generation of the data collection templates may be performed in consideration of factors that may improve efficiency of autonomous processing and warehouse personnel. For example, a lowest possible height location within the receiving facility topology (e.g., a lowest location on a shelf) that includes all relevant sources of RFID data may be used. Additionally, the data collection process may begin immediately, with report delivery delayed until the shipment arrives to distribute processing over time and bandwidth. The reporting structure may be configured to align with how packages will move through portals and what information is to be validated. RFID tags that are not of interest may be filtered out as early as possible in the processing. Reporting load may further be reduced by reporting only the count for items received. This may enhance efficiency by reducing network bandwidth and increasing the speed of the validation processing. Ensuring the reliability of the count may be performed, for example, using an inclusion filter with only tags that are contained within the package as well as information that may be used to access a particular node within a particular package level structure. Rejected packages may be inventoried as many times as desired without requiring a system reset. Packages can be inventoried and validated in any order. Multiple pallets, cases, packages, and items may be inventoried and validated simultaneously (e.g., concurrently) at the same portal or across multiple portals where business processes and the physical portal(s) are configured for multiple package processing. Further, multiple received shipments may be processed simultaneously (e.g., concurrently) across a single portal or multiple portals within a receiving facility, as appropriate for a given implementation. Further, the centralization provided by the inventory controller 102 may further improve efficiency for receiving and validating reports.

At block 408, the process 400 schedules submittal of the generated data collection template for processing an order for autonomous receipt based upon an anticipated (or actual) shipping date or an expected arrival date. The anticipated shipping data or the expected arrival data may form a portion of the advance shipment data. For implementations where the advance shipment data does not include anticipated shipping data or expected arrival data, this processing may be considered optional. For implementations where actual shipping information is provided by a vendor, this information may be utilized upon arrival of this information to schedule submittal of the template for processing the order for autonomous receipt. Scheduling the submittal of the template for processing the order for autonomous receipt may further increase efficiency while preserving autonomy of the inventory controller 102. The system may be considered configured to receive and validate the shipment upon arrival.

FIG. 5 is a flow chart of an example of an implementation of a process 500 for processing advance shipment data to facilitate autonomous validation of received shipments. At decision point 502, the process 500 makes a determination as to whether advance shipment data has been received. For example, an advance ship notice (ASN) may be received that provides the advance shipment data. However, other forms of input may provide the advance shipment data without departure from the scope of the present subject matter.

In response to determining that advance shipment data has been received, the process 500 parses the advance shipment data and inspects the message to ensure that all data for configuring receipt of a shipment is present at block 504. For example, the advance shipment data may be routed to a parser capable of understanding the message format, such as the advance shipment data parser 222. At decision point 506, the process 500 makes a determination as to whether all data for configuring receipt of a shipment is present. Data for configuring receipt of a shipment may be different for any given implementation. However, examples of data for configuring receipt of a shipment include a hierarchical structure of the shipment (e.g., certain items are in a particular case that is on an identified pallet which is part of this order, an RFID tag ID is present for each element within the hierarchy that is to be autonomously inventoried and validated). Additional unique identifier information/data, such as a derivable identifier for the shipment that is universally unique, a derivable identifier for each package level other than the root that is unique within the shipment, a target shipping date or estimated date of arrival, etc., may also be included in the advance shipment data.

In response to determining that all data for configuring receipt of a shipment is not present at decision point 506, the process 500 rejects the advance shipment data at block 508 and returns to decision point 502 to await new advance shipment data. The process 500 may also generate a notification that information is missing from the advance shipment data.

In response to determining that all data for configuring receipt of a shipment is present at decision point 506, the process 500 inspects the data to determine whether the data contains any unique RFID information/data at decision point 510. In response to determining that the data does not include any unique RFID information/data at decision point 510, the process 500 generates unique identifiers for each package level at block 512.

For purposes of example, the following pseudo listing represents an example of advance shipment data using the Healthcare Distribution Management Association (HDMA) industry guidelines for ANSI ASC X12 ASN format to help illustrate how the data may be extracted. Primary data is highlighted with a double carat (i.e., >>) after the optional information. Available optional data is highlighted as bolded data.

ISA*00* *00* *11*SenderId *ZZ*ReceiverId
*090713*0900*U*00401*000000001*0*P*>
GS*SH*SenderCode*ReceiverCode*20090713*0900*1*X*004010
ST*856*1
BSN*00*00123456789*20090713*0900
HL*1**S*1
TD1**48****G*5.52*LB
TD5**2**M**CC
REF*CN
DTM*011*20090713
DTM*017*20090719
N1*ST*Some Ship To*11*IdentificationCode
N3*123 Some Street
N4*Some City*NC*27617*US
N1*SF*Some Ship From*11*IdentificationCode
N3*456 Some Street
N4*Some City*DE*01234*US
HL*2*1*O*1>>
PRF*0123ABCD***20090713
REF*CN
DTM*003
HL*3*2*T*1>>
MAN*GM*urn:epc:tag:sscc-96:2.012345.00000100133>>
HL*4*3*P*1>>
MAN*SI*urn:epc:tag:sgtin-96:2.012345.6040134.300033>>
HL*5*4*I>>
LIN*1*ND*00078040134***LT*F0004
SN1*1*5*EA
SLN*1**I******SN*urn:epc:tag:sgtin-96:1.012345.6040134.24935>>
SLN*1**I******SN*urn:epc:tag:sgtin-96:1.012345.6040134.24936>>
SLN*1**I******SN*urn:epc:tag:sgtin-96:1.012345.6040134.24937>>
SLN*1**I******SN*urn:epc:tag:sgtin-96:1.012345.6040134.24938>>
SLN*1**I******SN*urn:epc:tag:sgtin-96:1.012345.6040134.24943>>
PID*F****GLEEVEC FCT 100MG 90
DTM*036*20100228
HL*6*3*P*1>>
MAN*SI*urn:epc:tag:sgtin-96:2.012345.6043815.500004>>
HL*7*6*I>>
LIN*2*ND*00078043815***LT*F0062
SN1*2*5*EA
SLN*2**I******SN*urn:epc:tag:sgtin-96:1.012345.6043815.55101>>
SLN*2**I******SN*urn:epc:tag:sgtin-96:1.012345.6043815.55102>>
SLN*2**I******SN*urn:epc:tag:sgtin-96:1.012345.6043815.55103>>
SLN*2**I******SN*urn:epc:tag:sgtin-96:1.012345.6043815.55104>>
SLN*2**I******SN*urn:epc:tag:sgtin-96:1.012345.6043815.55109>>
PID*F****NONAME TA 100MG 30 (DIVISIBLE)
DTM*036*20100228
HL*8*2*T*1>>
MAN*GM*urn:epc:tag:sscc-96:2.012345.00000100134>>
HL*9*8*P*1>>
MAN*SI*urn:epc:tag:sgtin-96:2.012345.6040134.300034>>
HL*10*9*I>>
LIN*3*ND*00078040134***LT*F0004
SN1*3*5*EA
SLN*3**I******SN*urn:epc:tag:sgtin-96:1.012345.6040134.24950>>
SLN*3**I******SN*urn:epc:tag:sgtin-96:1.012345.6040134.24951>>
SLN*3**I******SN*urn:epc:tag:sgtin-96:1.012345.6040134.24952>>
SLN*3**I******SN*urn:epc:tag:sgtin-96:1.012345.6040134.24953>>
SLN*3**I******SN*urn:epc:tag:sgtin-96:1.012345.6040134.24954>>
PID*F****GLEEVEC FCT 100MG 90
DTM*036*20100228
HL*11*8*P*1>>
MAN*SI*urn:epc:tag:sgtin-96:2.012345.6043815.500005>>
HL*12*11*I>>
LIN*4*ND*00078043815***LT*F0062
SN1*4*5*EA
SLN*4**I******SN*urn:epc:tag:sgtin-96:1.012345.6043815.55110>>
SLN*4**I******SN*urn:epc:tag:sgtin-96:1.012345.6043815.55111>>
SLN*4**I******SN*urn:epc:tag:sgtin-96:1.012345.6043815.55112>>
SLN*4**I******SN*urn:epc:tag:sgtin-96:1.012345.6043815.55113>>
SLN*4**I******SN*urn:epc:tag:sgtin-96:1.012345.6043815.55114>>
PID*F****NONAME TA 100MG 30 (DIVISIBLE)
DTM*036*20100228
CTT*12
SE*112*1
GE*1*1
IEA*1*000000001

With regard to the primary data, the hierarchical structure of the shipment is described by the “HL” segments, which include the Hierarchical ID Number (HL01), the Hierarchical Parent ID Number (HL02), and the Hierarchical Level Code (HL03, S=Shipment, O=Order, T=Tare/Pallet, P=Pack/Case, I=Item) data elements. For example, HL*4*3*P*1 indicates a case (or pack) contained within the pallet (or tare) indicated by HL*3*2*T*1. Overall, the ASN describes a hierarchy of two pallets each containing two cases which each contain five items. For pallets and cases, the RFID tag IDs may be obtained from the “MAN” segments using the marks and numbers (e.g., MAN02) data element value. For items, the tag IDs come from the “SLN” segments using the product/service ID (e.g., SLN10) data element value. In terms of optional data, the ASN provides a universally unique identifier for the shipment level derived from a combination of the interchange sender ID (e.g., ISA06) and shipment identification (e.g., BSN02) data element values within the ISA and BSN segments. The identifier for the order level may be extracted from the purchase order number (e.g., PRF01) data element value within the PRF segment. For pallets, cases, and items, the identifiers may be derived from the relevant “HL” segments using the “HL01” and “HL02” data element values all the way up the hierarchy. For example, the item level indicated by HL*7*6*I would have an identifier of “7-6-3-2-1”. The ASN also provides an expected arrival date of “20090719” within the “DTM” segment identified by code “017.”

Returning to the description of decision point 510, in response to determining that the message includes unique RFID information/data, the process 500 converts the advance shipment data into a generic package level data model at block 514. FIG. 6 described below depicts an example package level data model/structure.

Once the package level data model/structure shown and described in association with FIG. 6 below has been generated, it is persisted/stored to the data store at block 516. The package level data structure may be used for (1) defining data collection templates indicating how the RFID data should be processed and (2) validating the received RFID data against the original shipment information.

At decision point 518, the process 500 makes a determination as to whether the advance shipment data includes any optional ship or arrival date information. In response to determining that the advance shipment data does not include the optional ship or arrival date information, the process 500 generates a data collection template from the advance shipment data at block 520. The data collection template is transmitted to the data collector immediately at block 522 given the uncertainty of arrival date.

Alternatively, in response to determining that the advance shipment data includes the optional ship or arrival date information at decision point 518, the process 500 configures a scheduler, such as the scheduler module 224, to schedule a receiving task at block 524. The receiving task may be scheduled, for example, using IBM® WebSphere® Application Server Scheduler. Not submitting the data collection template until the day of arrival of a shipment may increase system efficiency because it minimizes the time when there is one more active application receiving tags that may not possibly be included (because the shipment hasn't arrived yet). For purposes of example, an implementation of the EPCGlobal® Application Level Events (ALE) specification as the data collector may be used to implement the data collector module 228. However, other types of data collectors may be used. Any mechanism capable of providing the following functionality would suffice: (1) generally, accumulate, filter, group, and report RFID tag data; (2) generally, submit data collection templates describing how data should be accumulated, processed, and reported; (3) associate a name with the template that will be returned as part of the report; (4) specify a single logical location name that is mapped to many physical devices capable of reading RFID tag data; (5) specify a time interval as part of the template indicating how long after which no new tags are seen the report should be delivered; (6) specify a name for the report within the template that will be returned as part of the report; (7) suppress empty reports if multiple report definitions can be included within the same template; (8) include all tags of interest seen since the last report was issued in the next report; (9) specify a list of tags of interest to be included within the report (to the exclusion of all others); (10) report only the count of tags; and (11) specify a URI to which reports will be delivered. This listing is but one possible set of functionality. Other functionality may be provided without departure from the scope of the present subject matter. Note that any ALE implementation would implicitly satisfy general functionality (1) and (2). The following represents an ALE 1.1.1 specification ECSpec wrapped within the simple object access protocol/extensible markup language/hypertext transfer protocol (SOAP/XML/HTTP) binding for a “Define” request to help illustrate how the package level data may be used within a data collection template and then transmitted to the data collector module 228, which again may include ALE. It is noted that ALE supports the ability to specify more than one report request within the same template. This is not listed as a primary feature, however, because in the alternative, separate templates may be submitted for each report.

Data originally extracted from the ASN is highlighted as bolded. Other data significant to the required functionality of the data collector is highlighted in bold.

```
<?xml version=“1.0” encoding=“UTF-8”?>
<soapenv:Envelope
  xmlns:impl=“urn:epcglobal:ale:wsdl:1”
  xmlns.soapenv=“http://schemas.xmlsoap.org/soap/envelope/”
  xmlns.xsd=“http://www.w3.org/2001/XMLSchema”
  xmlns.xsi=“http://www.w3.org/2001/XMLSchema-instance”
>
  <soapenv:Body>
    <impl:Define>
      <impl:specName>SenderId-00123456789</impl:specName>
      <impl:spec
          creationDate=“2009-07-19T10:54:06.444-05:00”
          schemaVersion=“1.1”
          xmlns=“urn:epcglobal:ale:xsd:1”
      >
        <logicalReaders>
          <logicalReader>Receiving</logicalReader>
        </logicalReaders>
        <boundarySpec>
          <stableSetInterval unit=“MS”>3000</stableSetInterval>
        </boundarySpec>
        <reportSpecs>
          <reportSpec reportName=“3-2-1” reportIfEmpty=”false”>
            <reportSet set=“CURRENT”/>
            <filterSpec>
              <extension>
                <filterList>
                  <filter>
                    <includeExclude>INCLUDE</includeExclude>
                    <fieldspec>
                      <fieldname>epc</fieldname>
                    </fieldspec>
                    <patList>
                      <pat>urn:epc:pat:sscc-96:2.012345.00000100133</pat>
                      <pat>urn:epc:pat:sgtin-96:2.012345.6040134.300033</pat>
                      <pat>urn:epc:tag:sgtin-96:1.012345.6040134.24935</pat>
                      <pat>urn:epc:tag:sgtin-96:1.012345.6040134.24936</pat>
                      <pat>urn:epc:tag:sgtin-96:1.012345.6040134.24937</pat>
                      <pat>urn:epc:tag:sgtin-96:1.012345.6040134.24938</pat>
                      <pat>urn:epc:tag:sgtin-96:1.012345.6040134.24943</pat>
                      <pat>urn:epc:pat:sgtin-96:2.012345.6043815.500004</pat>
                      <pat>urn:epc:tag:sgtin-96:1.012345.6043815.55101</pat>
                      <pat>urn:epc:tag:sgtin-96:1.012345.6043815.55102</pat>
                      <pat>urn:epc:tag:sgtin-96:1.012345.6043815.55103</pat>
                      <pat>urn:epc:tag:sgtin-96:1.012345.6043815.55104</pat>
                      <pat>urn:epc:tag:sgtin-96:1.012345.6043815.55109</pat>
                    </patList>
                  </filter>
                </filterList>
              </extension>
            </filterSpec>
            <output includeCount=“true”/>
          </reportSpec>
          <reportSpec reportName=“8-2-1” reportIfEmpty=”false”>
            <reportSet set=“CURRENT”/>
            <filterSpec>
              <extension>
                <filterList>
                  <filter>
                    <includeExclude>INCLUDE</includeExclude>
                    <fieldspec>
                      <fieldname>epc</fieldname>
                    </fieldspec>
                    <patList>
                      <pat>urn:epc:pat:sscc-96:2.012345.00000100134</pat>
                      <pat>urn:epc:pat:sgtin-96:2.012345.6040134.300034</pat>
                      <pat>urn:epc:tag:sgtin-96:1.012345.6040134.24950</pat>
                      <pat>urn:epc:tag:sgtin-96:1.012345.6040134.24951</pat>
                      <pat>urn:epc:tag:sgtin-96:1.012345.6040134.24952</pat>
                      <pat>urn:epc:tag:sgtin-96:1.012345.6040134.24953</pat>
                      <pat>urn:epc:tag:sgtin-96:1.012345.6040134.24954</pat>
                      <pat>urn:epc:pat:sgtin-96:2.012345.6043815.500005</pat>
                      <pat>urn:epc:tag:sgtin-96:1.012345.6043815.55110</pat>
                      <pat>urn:epc:tag:sgtin-96:1.012345.6043815.55111</pat>
                      <pat>urn:epc:tag:sgtin-96:1.012345.6043815.55112</pat>
                      <pat>urn:epc:tag:sgtin-96:1.012345.6043815.55113</pat>
                      <pat>urn:epc:tag:sgtin-96:1.012345.6043815.55114</pat>
                    </patList>
                  </filter>
                </filterList>
              </extension>
            </filterSpec>
            <output includeCount=“true”/>
          </reportSpec>
        </reportSpecs>
      </impl:spec>
    </impl:Define>
  </soapenv:Body>
</soapenv:Envelope>
```

The <specName> element includes the shipment identifier as derived from the ASN. The identifier is unique to avoid conflicts with other data collection templates within the collector. ALE may include the specification name as part of the report. This information may be used by the inventory controller 102 to locate the original shipment information within the data store. This satisfies functionality (3) described above.

The <logicalReader> element includes the name of the location serving as the source of RFID data within the topology as described above in association with configuration of the inventory controller 102. This instructs the ALE to forward all tags originating from any logical reader underneath “Receiving” (e.g., receiving element 304 within FIG. 3) within the receiving facility model (e.g., the receiving facility model 300) to the event cycle for possible inclusion within the report. This satisfies functionality (4) described above.

The <stableSetInterval> element includes the time interval after which a report should be generated if no new tags are identified. A timer, such as the timer/clock module 234, may be started when the first tag that passes the filter arrives. The timer may end after a configured time (e.g., three seconds) has expired with no new tags identified via the filter. Then a report may be generated, which satisfies functionality (5) described above.

The reportName attribute within the <reportSpec> element represents the unique identifier assigned to the pallet within the package level structure (See FIG. 6 described below). This information may be used to locate the package level model being validated within the total structure obtained previously using the specification name. This satisfies functionality (6) described above.

The value of the reportIfEmpty attribute within the <reportSpec> element tells ALE to suppress empty reports. This is useful when the ECSpec includes multiple report specifications (e.g., one per pallet) so that pallets other than the one currently moving through the portal are not improperly rejected. This satisfies functionality (7) described above.

The value of the set attribute within the <reportSet> element instructs ALE to report all tags that passed the filter between delivery of the last report and when the stable set interval timer ends. Reporting this set of tags, as opposed to additions or deletions, enhances system autonomy with regard to re-interrogating rejected packages. This satisfies functionality (8) described above.

The value of the <includeExclude> element tells ALE that, for filtering, it may include any tag that matches any of the patterns defined as part of the <pat> elements. This may enhance system efficiency because tags that are not of interest may be discarded as early as possible in the process. This satisfies functionality (9) described above.

The value of the includeCount attribute within the <output> element instructs ALE to only report the tag count. This may also enhance system efficiency with regard to network bandwidth and validation speed. Validating against only the count is possible because the filter provides that only the relevant tags are counted. This satisfies functionality (10) described above.

After the ECSpec has been defined with the data collector module 228 (e.g., ALE), the data collection template generator module 226 may then subscribe to the template to satisfy functionality (11) described above. This may be performed by sending a “Subscribe” request including the ECSpec name and a notification uniform resource identifier (URI) using the SOAP/XML/HTTP binding, as the following pseudo syntax illustrates.

```
<?xml version=“1.0” encoding=“UTF-8”?>
<soapenv:Envelope
        xmlns:impl=“urn:epcglobal:ale:wsdl:1”
        xmlns:soapenv=“http://schemas.xmlsoap.org/soap/envelope/”
        xmlns:xsd=“http://www.w3.org/2001/XMLSchema”
        xmlns:xsi=“http://www.w3.org/2001/XMLSchema-instance”>
  <soapenv:Body>
    <impl:Subscribe>
      <impl:specName>SenderId-00123456789</impl:specName>
      <impl:notificationURI>http://hostname:9080/validation/client
      </impl:notification
    URI>
    </impl:Subscribe>
  </soapenv:Body>
</soapenv:Envelope>
```

Returning to the description of FIG. 5, upon configuring a scheduler, such as the scheduler module 224, to schedule a receiving task at block 524, the process 500 activates the scheduler at block 526, at the scheduled time, to execute the scheduled task. The process 500 returns to block 520 to generate the data collection template, and transmits it to the data collector at block 522, as described above. Once the data collection template has been generated and submitted to the data collector module 228, the process 500 may await the arrival of the shipment. The process 500 then returns to decision point 502 to await receipt of new advance shipment data.

FIG. 6 is a block diagram of an example of an implementation of a package level data model/structure 600 stored within a memory that may be used to create package level data models/structures for orders. The package level data model/structure 600 is shown stored within the advance shipment information storage area 212 of the memory 208.

The package level data model/structure 600 is a hierarchical arrangement of nodes. A root package entity 602 represents a higher-level root node that is a top level of the hierarchical arrangement of nodes. A package level is a set of nodes all sharing the same parent. As such, a package level 604 includes the root package entity 602. Similarly, a package level 606, a package level 608, a package level 610, and a package level 612 define additional hierarchical levels within the package level data model/structure 600.

Within each package level 606 through 610, package nodes represent a discrete entity within the respective level. A package entity_1 614 node, a package entity_2 616 node, through a package entity_N 618 node make up the package level 606. Similarly, a package entity_1 620 node, a package entity_2 622 node, through a package entity_M 624 node make up the package level 608 within the present example. Likewise, a leaf package entity_1 626 node, a leaf package entity_2 628 node, through a leaf package entity_P 630 node make up the package level 610 and a leaf package entity_1 632 makes up the package level 612 within the present example. Leaf package entities may be considered an end node within a package level data model/structure. While the present example shows general organization for the example package level data model/structure 600, it is understood that each advance shipment notification (ASN) may be used to create and store a package level data model/structure within a memory.

Package entity nodes within the same level may be heterogenous and represent disparate entity types. Information within a node may include hierarchical data (e.g., its place within the overall structure), entity type, an identifier unique within the structure (except for the root node which may have an identifier unique among all structures), and zero or more RFID tag IDs. A package entity represents some type of real world packaging structure and may be either abstract or concrete. Examples of abstract entities may include a shipment and an order. Examples of concrete entities may include pallets, cases, and items. Concrete entities represent one or more items to be validated upon arrival of a shipment.

An entity may also be either unary or composite, the latter indicating that a single entity may homogeneously represent many items/pallets/packages, etc. Abstract entities may be considered to include zero RFID tag IDs. Unary concrete entities may include one RFID tag ID. Composite concrete entities may include many RFID tag IDs.

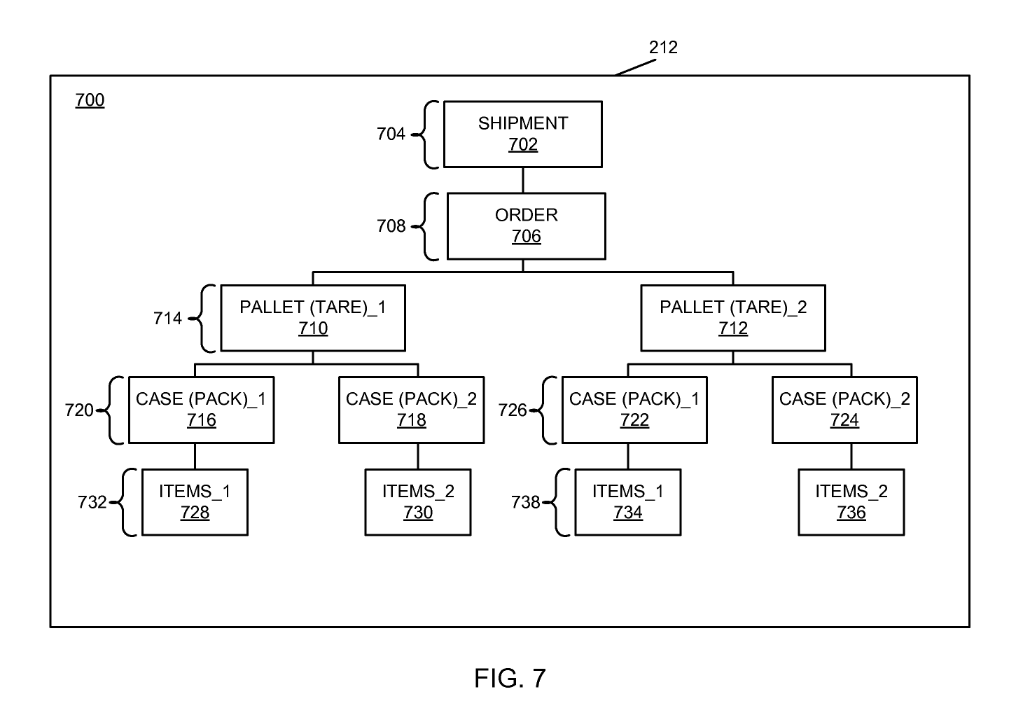

FIG. 7 is a block diagram of an example of an implementation of a package level data model/structure 700 stored within a memory and derived from the example pseudo listing of advance shipment data in the advance shipment notification described above. The package level data model/structure 700 is shown stored within the advance shipment information storage area 212 of the memory 208 and may be considered a data collection model.

A shipment node 702 represents a root node within the package level data model/structure 700 at a level 704. An order node 706 is shown within a level 708. A pallet (tare)_1 node 710 and a pallet (tare)_2 node 712 are shown within a level 714. A case (pack)_1 node 716 and a case (pack)_2 node 718 are shown within a level 720. A case (pack)_1 node 722 and a case (pack)_2 node 724 are shown within a level 726. An items_1 node 728 and an items_2 node 730 are shown within a level 732. Similarly, an items_1 node 734 and an items_2 node 736 are shown within a level 738. The shipment node 702 and order node 706 are considered abstract entities. The pallet (tare)_1 node 710, the pallet (tare)_2 node 712, the case (pack)_1 node 716, the case (pack)_2 node 718, the case (pack)_1 node 722, and the case (pack)_2 node 724, and the items_1 node 728, the items_2 node 730, the items_1 node 734, and the items_2 node 736 are considered concrete entities. The items_1 node 728, the items_2 node 730, the items_1 node 734, and the items_2 node 736 are also considered composite entities. All others are unary. The following diagram again depicts the general package level data model/structure 700 derived from the ASN but also adds the extracted data that has been mapped into the package level data model/structure 700.

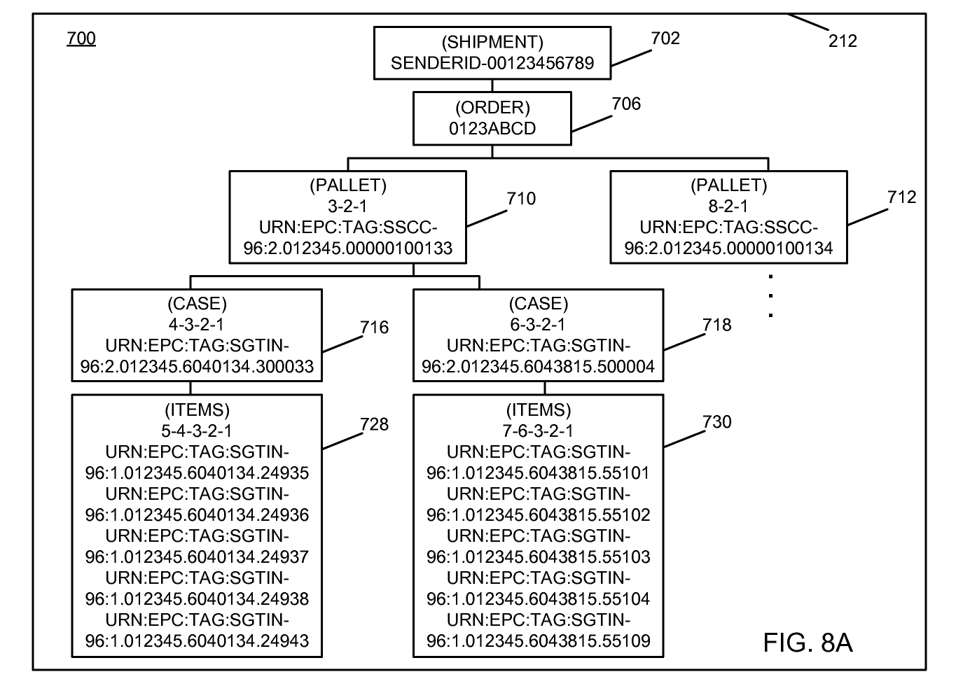

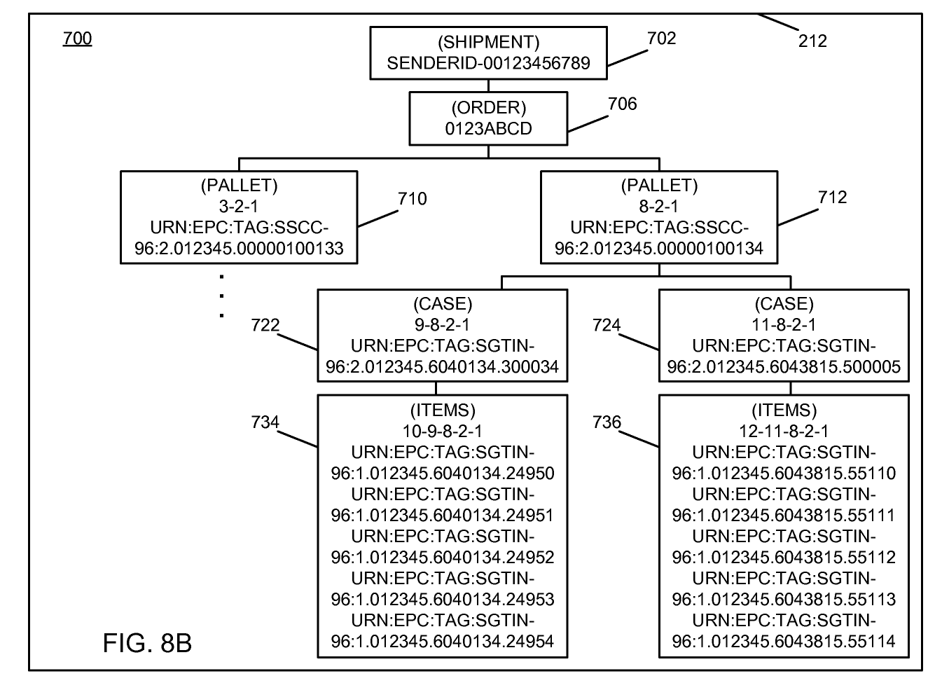

The package level data model/structure 700 will be used below, beginning with FIG. 8A to show the extracted data of the received ASN (shown and described above) mapped into the nodes of the example package level data model/structure 700 derived from the example pseudo listing of advance shipment data in the advance shipment notification described above. The level enumerations are omitted to reduce complexity within the figures described below.

FIG. 8A is a block diagram of a first portion of an example of an implementation of the package level data model/structure 700 of FIG. 7 stored within a memory with a first portion of the advance shipment data within the advance shipment notification described above populated into the package level data model/structure 700. The package level data model/structure 700 is again shown stored within the advance shipment information storage area 212 of the memory 208. Comparison of the fields of the ASN described above with FIG. 8A shows that fields from the ASN have been mapped into the package level data model/structure 700. These fields may be used during receipt of a shipment, as described in more detail below.

FIG. 8B is a block diagram of a second portion of an example of an implementation of the package level data model/structure 700 of FIG. 7 stored within a memory with a second portion of the advance shipment data within the advance shipment notification described above populated into the package level data model/structure 700. The package level data model/structure 700 is again shown stored within the advance shipment information storage area 212 of the memory 208. Comparison of the fields of the ASN described above with FIG. 8A shows that fields from the ASN have been mapped into the package level data model/structure 700. These fields may be used during receipt of a shipment, as described in more detail below.

FIG. 9 is a flow chart of an example of an implementation of a process 900 for processing a shipment arrival using autonomous validation of received shipments. At block 902, the process 900 receives, at an inventory controller device, advance shipment data associated with a shipment. At block 904, the process 900 verifies the advance shipment data. At block 906, the process 900 generates a data collection model based upon the advance shipment data. At block 908, the process 900 stores the generated data collection model within a memory. At block 910, the process 900 autonomously validates the shipment via the inventory controller device in response to receipt of the shipment using the generated data collection model. At block 912, the process 900 generates an indication of a target storage location within a receiving facility for each container of the validated shipment using a defined location topology model of the receiving facility comprising available storage locations.

FIG. 10 is a flow chart of an example of an implementation of a process 1000 for validating a shipment upon arrival using the advance shipment data encoded within a stored package level data model/structure to facilitate autonomous validation of received shipments. As described above, when a shipment arrives, the inventory controller 102 may already be configured to receive it as described above. No further action is necessary and the normal receiving process may commence.

At decision point 1002, the process 1000 makes a determination as to whether a shipment has arrived. Containers (pallets within the present example) may be unloaded, either in an automated manner via a conveyor or manually via a fork lift or conveyor, from the trailer or truck and moved through a dock door (e.g., an RFID portal), each with an attached RFID interrogator (e.g., the RFID reader_1 318 through the RFID reader_T 324).

At block 1004, the process 1000 detects one or more pallets moving via the RFID interrogator. At block 1006, the process 1000 reads pallet, case, and item level tags from the detected one or more pallets. Data from reading RFID tags may be propagated through the receiving facility to the inventory controller 102 and the data collector module 228. Upon detection of the first expected pallet, case, or item RFID tag, the stable set interval timer, such as the timer/clock module 234, may be started. An example timer duration of, for example three (3) seconds, may be measured and when the duration has passed without detecting any new tags, a report may be generated and sent to the validator module 230. The immediate delivery of reports once all RFID tags within the inclusion filter specified by the package level data model have been read may increase the validation response time (e.g., eliminates unnecessary wait time for other conditions to occur). One or more validation strategies may be invoked upon the generation of any report, and these validation strategies may be established in association with a package level data model. Implementations of validation strategies may be registered with the inventory controller 102 either statically at the time of initialization or dynamically from remote clients via one or more network protocols.

The following is a sample report format with certain information bolded to highlight the portion of the shipment associated with this example report, as described in more detail below.

```
<?xml version=“1.0” encoding=“UTF-8”?>
<ECReports
    xmlns:xsi=“http://www.w3.org/2001/XMLSchema-instance”
    ALEID=“localhost@127.0.0.1”
    totalMilliseconds=“10559”
    specName=“SenderId-00123456789”
    terminationCondition=“STABLE_SET”
    schemaVersion=“1.1”
    xmlns:ale=“urn:epcglobal:ale:xsd:1”
    creationDate=“2009-07-26T12:31:24.156-05:00”
    date=“2009-07-26T13:31:10.750-05:00”
    initiationCondition=“REQUESTED”
>
  <reports>
    <report reportName=“3-2-1”>
      <group>
        <groupCount>
          <count>13</count>
        </groupCount>
      </group>
    </report>
  </reports>
</ECReports>
```

At block 1008, the validator module 230 receives the report(s) from the data collector module 228. At block 1010, the process 1000 uses the data collection template name identified within the report(s) to identify a package level data model, such as the package level data model/structure 700 stored within the advance shipment information storage area 212 of the memory 208. As such, the validator module 230 retrieves the package level structure from the memory 208 that maps to the value of the specName attribute of the <ECReports> element within the report(s).

At block 1012, the package level node that maps to the value of the reportName attribute of the <report> element is then identified. At block 1014, the process 1000 compares the report count and the node count. For example, based on the validation depth, the validator module 230 may calculate an expected count and compare it to the value of the <count> element, taking the validation threshold into consideration. The process 1000 may further determine in association with the comparison whether the RFID identifier associated with each item of the shipment passing through the one of the plurality of portals of the receiving facility matches an RFID identifier associated with the advance shipment data within the data collection model.

At decision point 1016, the process 1000 makes a determination as to whether the report count equals the node count. In response to determining that the report count equals the node count from the package level data model, the process 1000 accepts the pallet at block 1018. In response to determining that the report count does not equal the node count from the package level data model, the process 1000 rejects the pallet at block 1020. An accept or reject message may be delivered that may result in a visual or audio display at the portal, queuing either a forklift operator to continue to store the pallet within the receiving facility or to rescan the pallet (e.g., drive back through the portal), or to cause an automated conveyor to reverse and send the pallet back through the portal, respectively.

In response to accepting the pallet at block 1018 or rejecting the pallet at block 1020, the process 1000 makes a determination as to whether all reports have been processed at decision point 1022. In response to determining that all reports have not been processed, the process 1000 selects the next report at block 1024 and returns to block 1012 and iterates as described above. In response to determining that all reports have been processed, the process 1000 makes a determination at decision point 1026 as to whether all pallets have passed autonomous validation. In response to determining that at least one pallet has not passed autonomous validation, the process 1000 returns to block 1004, as described above, to process any pallet that has to be rescanned through the portal.

In response to determining that all pallets have passed autonomous validation, the process 1000 makes a determination at decision point 1028 as to whether the accepted total item count equals the expected total item count from the package level data model, such as the package level data model/structure 700, stored within the advance shipment information storage area 212 of the memory 208. In response to determining that the accepted total item count equals the expected total item count, the process 1000 accepts the shipment at block 1030. In response to determining that the accepted total item count does not equal the expected total item count, the process 1000 rejects the shipment at block 1032. It should be understood that total counts may be based upon total pallet counts or other granularity as appropriate for a given implementation. In response to either accepting or rejecting the shipment, the process 1000 returns to decision point 1002 to await another shipment.

Note that the process 1000 allows for the possibility of multiple shipments to be received and autonomously processed, and for multiple reports to be issued concurrently. For example, if the vendor's receiving process allows for more than one pallet at a time to move through the portal, both scanning and reports may be received and processed concurrently within the example scenario, and the validator module 230 may iteratively process the reports to allow receipt of more than one concurrent order, each received through multiple portals. Further, each shipment may be received through one or more portals in addition to the concurrent processing of multiple orders and reports. The following shows what an example report may look like in this case, again with certain information bolded for correlation with the ASN and pallet report described above.

```
<?xml version=“1.0” encoding=“UTF-8”?>
<ECReports
    xmlns:xsi=“http://www.w3.org/2001/XMLSchema-instance”
    ALEID=“localhost@127.0.0.1”
    totalMilliseconds=“10559”
    specName=“SenderId-00123456789”
    terminationCondition=“STABLE_SET”
    schemaVersion=“1.1”
    xmlns:ale=“urn:epcglobal:ale:xsd:1”
    creationDate=“2009-07-26T12:31:24.156-05:00”
    date=“2009-07-26T13:31:10.750-05:00”
    initiationCondition=“REQUESTED”
>
  <reports>
    <report reportName=“3-2-1”>
    <group>
      <groupCount>
        <count>13</count>
      </groupCount>
      </group>
    </report>
    <report reportName=“8-2-1”>
      <group>
        <groupCount>
          <count>13</count>
        </groupCount>
      </group>
    </report>
  </reports>
</ECReports>
```

As described above in association with FIG. 1 through FIG. 10, the example systems and processes provide autonomous validation of received shipments. Many other variations and additional activities associated with autonomous validation of received shipments are possible and all are considered within the scope of the present subject matter.

Those skilled in the art will recognize, upon consideration of the above teachings, that certain of the above examples are based upon use of a programmed processor, such as the CPU 200. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
receiving, at an inventory controller device, advance shipment data associated with a shipment;
verifying the advance shipment data;
generating a data collection model based upon the advance shipment data;
storing the generated data collection model within a memory;
autonomously validating the shipment via the inventory controller device in response to receipt of the shipment using the generated data collection model; and
generating an indication of a target storage location within a receiving facility for each container of the validated shipment using a defined location topology model of the receiving facility comprising available storage locations.

2. The method of claim 1, where verifying the advance shipment data comprises:
parsing the advance shipment data; and
determining whether item data associated with each item of the shipment is present within the advance shipment data; and
further comprising rejecting the advance shipment data in response to determining that the item data associated with each item of the shipment is not present within the advance shipment data.

3. The method of claim 1, where generating a data collection model based upon the advance shipment data comprises:
determining whether unique radio frequency identification (RFID) information is available within the advance shipment data for each item of the shipment;
generating unique RFID identifiers for each package level within the data collection model in response to determining that the unique RFID information is not available within the advance shipment data for each item of the shipment; and
converting the advance shipment data into the data collection model comprising any generated unique RFID information.

4. The method of claim 1, further comprising:
determining whether arrival scheduling information is available within the advance shipment data;
configuring a scheduled arrival time of the shipment in response to determining that the arrival scheduling information is available within the advance shipment data; and
activating processing of the generated data collection model in association with the scheduled arrival time of the shipment.

5. The method of claim 1, where generating a data collection model based upon the advance shipment data comprises:
mapping elements of the advance shipment data associated with each item of the shipment to nodes within the data collection model.

6. The method of claim 5, where autonomously validating the shipment via the inventory controller device in response to receipt of the shipment using the generated data collection model comprises:
detecting a container of the shipment passing through a portal of the receiving facility via a radio frequency identification (RFID) interrogator;
reading at least one of a pallet RFID tag, at least one case RFID tag, and at least one item RFID tag associated with the container of the shipment via the RFID interrogator; and
generating a report including the at least one of the pallet RFID tag, the at least one case RFID tag, and the at least one item RFID tag and a report count of items associated with the container of the shipment.

7. The method of claim 6, where autonomously validating the shipment via the inventory controller device in response to receipt of the shipment using the generated data collection model further comprises:
comparing the report count and the at least one of the pallet RFID tag, the at least one case RFID tag, and the at least one item RFID tag within the generated report to at least one mapped element of the advanced shipment data associated with the nodes within the data collection model;
determining whether the report count of the report equals a node count of the at least one mapped element of the advanced shipment data;
rejecting the container of the shipment in response to determining that the report count of the report does not equal the node count of the at least one mapped element of the advanced shipment data; and
accepting the container of the shipment in response to determining that the report count of the report equals the node count of the at least one mapped element of the advanced shipment data.

8. The method of claim 1, where autonomously validating the shipment via the inventory controller device in response to receipt of the shipment using the generated data collection model comprises:
detecting, for each item of the shipment passing through one of a plurality of portals of the receiving facility, a radio frequency identification (RFID) identifier associated with each item of the shipment via an RFID interrogator;
comparing the RFID identifier associated with each item of the shipment passing through the one of the plurality of portals of the receiving facility with the advance shipment data within the data collection model;
determining whether the RFID identifier associated with each item of the shipment passing through the one of the plurality of portals of the receiving facility matches an RFID identifier associated with the advance shipment data within the data collection model;
accepting items of the shipment with RFID identifiers that match RFID identifiers associated with the advance shipment data within the data collection model;
accepting the shipment in response to determining that an accepted total item count equals an expected total item count identified within the advance shipment data within the data collection model; and
rejecting the shipment in response to determining that the accepted total item count does not equal the expected total item count identified within the advance shipment data within the data collection model.

9. A system, comprising:
a memory; and
a processor programmed to:
receive, at an inventory controller device, advance shipment data associated with a shipment;
verify the advance shipment data;
generate a data collection model based upon the advance shipment data;
store the generated data collection model in the memory;
autonomously validate the shipment in response to receipt of the shipment using the generated data collection model; and
generate an indication of a target storage location within a receiving facility for each container of the validated shipment using a defined location topology model of the receiving facility comprising available storage locations.

10. The system of claim 9, where, in being programmed to verify the advance shipment data, the processor is programmed to:
parse the advance shipment data; and
determine whether item data associated with each item of the shipment is present within the advance shipment data; and
where the processor is further programmed to reject the advance shipment data in response to determining that the item data associated with each item of the shipment is not present within the advance shipment data.

11. The system of claim 9, where, in being programmed to generate a data collection model based upon the advance shipment data, the processor is programmed to:
determine whether unique radio frequency identification (RFID) information is available within the advance shipment data for each item of the shipment;
generate unique RFID identifiers for each package level within the data collection model in response to determining that the unique RFID information is not available within the advance shipment data for each item of the shipment; and
convert the advance shipment data into the data collection model comprising any generated unique RFID information.

12. The system of claim 9, where the processor is further programmed to:
determine whether arrival scheduling information is available within the advance shipment data;
configure a scheduled arrival time of the shipment in response to determining that the arrival scheduling information is available within the advance shipment data; and
activate processing of the generated data collection model in association with the scheduled arrival time of the shipment.

13. The system of claim 9, where, in being programmed to generate a data collection model based upon the advance shipment data, the processor is programmed to:
map elements of the advance shipment data associated with each item of the shipment to nodes within the data collection model.

14. The system of claim 13, where, in being programmed to autonomously validate the shipment in response to receipt of the shipment using the generated data collection model, the processor is programmed to:
detect a container of the shipment passing through a portal of the receiving facility via a radio frequency identification (RFID) interrogator;
read at least one of a pallet RFID tag, at least one case RFID tag, and at least one item RFID tag associated with the container of the shipment via the RFID interrogator; and
generate a report including the at least one of the pallet RFID tag, the at least one case RFID tag, and the at least one item RFID tag and a report count of items associated with the container of the shipment.

15. The system of claim 14, where, in being programmed to autonomously validate the shipment in response to receipt of the shipment using the generated data collection model, the processor is further programmed to:
compare the report count and the at least one of the pallet RFID tag, the at least one case RFID tag, and the at least one item RFID tag within the generated report to at least one mapped element of the advanced shipment data associated with the nodes within the data collection model;
determine whether the report count of the report equals a node count of the at least one mapped element of the advanced shipment data;
reject the container of the shipment in response to determining that the report count of the report does not equal the node count of the at least one mapped element of the advanced shipment data; and
accept the container of the shipment in response to determining that the report count of the report equals the node count of the at least one mapped element of the advanced shipment data.

16. The system of claim 9, where, in being programmed to autonomously validate the shipment in response to receipt of the shipment using the generated data collection model, the processor is programmed to:
detect, for each item of the shipment passing through one of a plurality of portals of the receiving facility, a radio frequency identification (RFID) identifier associated with each item of the shipment via an RFID interrogator;
compare the RFID identifier associated with each item of the shipment passing through the one of the plurality of portals of the receiving facility with the advance shipment data within the data collection model;
determine whether the RFID identifier associated with each item of the shipment passing through the one of the plurality of portals of the receiving facility matches an RFID identifier associated with the advance shipment data within the data collection model;
accept items of the shipment with RFID identifiers that match RFID identifiers associated with the advance shipment data within the data collection model;
accept the shipment in response to determining that an accepted total item count equals an expected total item count identified within the advance shipment data within the data collection model; and
reject the shipment in response to determining that the accepted total item count does not equal the expected total item count identified within the advance shipment data within the data collection model.

17. A computer program product comprising a computer readable storage medium including computer readable program code, where the computer readable program code when executed on a computer causes the computer to:
receive advance shipment data associated with a shipment;
verify the advance shipment data;
generate a data collection model based upon the advance shipment data;
store the generated data collection model within a memory;
autonomously validate the shipment in response to receipt of the shipment using the generated data collection model; and
generate an indication of a target storage location within a receiving facility for each container of the validated shipment using a defined location topology model of the receiving facility comprising available storage locations.

18. The computer program product of claim 17, where, where in causing the computer to verify the advance shipment data, the computer readable program code when executed on the computer causes the computer to:
parse the advance shipment data; and
determine whether item data associated with each item of the shipment is present within the advance shipment data; and
where the computer readable program code when executed on the computer further causes the computer to reject the advance shipment data in response to determining that the item data associated with each item of the shipment is not present within the advance shipment data.

19. The computer program product of claim 17, where, where in causing the computer to generate a data collection model based upon the advance shipment data, the computer readable program code when executed on the computer causes the computer to:
determine whether unique radio frequency identification (RFID) information is available within the advance shipment data for each item of the shipment;
generate unique RFID identifiers for each package level within the data collection model in response to determining that the unique RFID information is not available within the advance shipment data for each item of the shipment; and
convert the advance shipment data into the data collection model comprising any generated unique RFID information.

20. The computer program product of claim 17, where the computer readable program code when executed on the computer further causes the computer to:
determine whether arrival scheduling information is available within the advance shipment data;
configure a scheduled arrival time of the shipment in response to determining that the arrival scheduling information is available within the advance shipment data; and
activate processing of the generated data collection model in association with the scheduled arrival time of the shipment.

21. The computer program product of claim 17, where, where in causing the computer to generate a data collection model based upon the advance shipment data, the computer readable program code when executed on the computer causes the computer to:
map elements of the advance shipment data associated with each item of the shipment to nodes within the data collection model.

22. The computer program product of claim 21, where, where in causing the computer to autonomously validate the shipment in response to receipt of the shipment using the generated data collection model, the computer readable program code when executed on the computer causes the computer to:
detect a container of the shipment passing through a portal of the receiving facility via a radio frequency identification (RFID) interrogator;
read at least one of a pallet RFID tag, at least one case RFID tag, and at least one item RFID tag associated with the container of the shipment via the RFID interrogator; and
generate a report including the at least one of the pallet RFID tag, the at least one case RFID tag, and the at least one item RFID tag and a report count of items associated with the container of the shipment.

23. The computer program product of claim 22, where, where in causing the computer to autonomously validate the shipment in response to receipt of the shipment using the generated data collection model, the computer readable program code when executed on the computer further causes the computer to:
compare the report count and the at least one of the pallet RFID tag, the at least one case RFID tag, and the at least one item RFID tag within the generated report to at least one mapped element of the advanced shipment data associated with the nodes within the data collection model;
determine whether the report count of the report equals a node count of the at least one mapped element of the advanced shipment data;
reject the container of the shipment in response to determining that the report count of the report does not equal the node count of the at least one mapped element of the advanced shipment data; and
accept the container of the shipment in response to determining that the report count of the report equals the node count of the at least one mapped element of the advanced shipment data.

24. The computer program product of claim 17, where, where in causing the computer to autonomously validate the shipment in response to receipt of the shipment using the generated data collection model, the computer readable program code when executed on the computer causes the computer to:
detect, for each item of the shipment passing through one of a plurality of portals of the receiving facility, a radio frequency identification (RFID) identifier associated with each item of the shipment via an RFID interrogator;
compare the RFID identifier associated with each item of the shipment passing through the one of the plurality of portals of the receiving facility with the advance shipment data within the data collection model;
determine whether the RFID identifier associated with each item of the shipment passing through the one of the plurality of portals of the receiving facility matches an RFID identifier associated with the advance shipment data within the data collection model;
accept items of the shipment with RFID identifiers that match RFID identifiers associated with the advance shipment data within the data collection model;
accept the shipment in response to determining that an accepted total item count equals an expected total item count identified within the advance shipment data within the data collection model; and
reject the shipment in response to determining that the accepted total item count does not equal the expected total item count identified within the advance shipment data within the data collection model.
